(19) United States
(12) Patent Application Publication
(10) Pub. No.: US 2007/0296592 A1
(43) Pub. Date: Dec. 27, 2007

(54) DISPLAY PANEL MODULE AND RADIO FREQUENCY IDENTIFICATION MODULE APPLIED THERETO

(76) Inventors: Chi-Fang Huang, Taipei (TW); Chia-Lin Liu, Taichung County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,130

(22) Filed: Jun. 26, 2006

(51) Int. Cl. G08B 13/14

(52) U.S. Cl. 340/572.7; 340/572.8

(57) ABSTRACT

A display panel module with a transparent radio frequency identification module is provided. The radio frequency identification module comprises a radio frequency identification chip and a transparent antenna electrically connected thereto. Since the antenna of the radio frequency identification module comprises transparent material, the antenna can be disposed on the surface of the display panel without views of the display panel being covered.

### BACKGROUND OF THE INVENTION

1. Field of the Invention

The present invention generally relates to a display panel, and more particularly to a display panel and a transparent radio frequency identification module applied thereto.

2. Description of Related Art

To conveniently control fabricating flow, quality and fabricating cost of a product, manufacturers have recently labeled the product with a bar code for identification and records of fabricating information including cost of raw material and quality of the product and fabricating specification, quality and the time for processing the product by each fabricating machine during the fabrication process. A database built for storing such information, which enables the operators of factory to only read the barcode of the product when controlling the fabricating flow of the product to easily search all fabricating information of the product. Accordingly, the factory operators can precisely calculate the fabrication cost and control the fabrication quality of the product as well as predict the shipment date as well based on the time for processing the product for each fabricating machine.

In addition to the conventional barcode, a radio frequency identification (FRID) system, which is non-contact automatically identification technology, has currently been adopted. The RFID system transmits signals via antenna without manual operation for reading records of barcode for information of the fabricating process by each fabricating machine and tracking the product, to expedite the fabrication flow of the product and to improve production efficiency.

However, installation of antenna in the external portion of the display panel is not suitable; therefore, the antenna of the RFID system can be only disposed on the reverse surface of the display panel. However, if the antenna is disposed on the reverse side of the display pane, the antenna fails to function after a rear cover assembled to the display panel. Additionally, if the antenna is disposed on the obverse side of the display panel(i.e. the display side), the view area of the display panel will be affected.

### SUMMARY OF THE INVENTION

Accordingly, the present invention is directed to a wireless radio frequency identification module, disposed on a display panel, thereby under a condition of not affecting the view area of the display panel, enabling a management for more production and easily maintaining each fabricating machine.

The present invention further relates to a liquid crystal display (LCD) panel in which an antenna is disposed on a surface of an outer plate and can transmit/receive all fabricating information regarding the LCD panel with improved convenience of production management of LCD panels and easier maintenance programs for fabricating machines.

The present invention is further directed to a radio frequency identification module, disposed on a surface of an LCD panel, comprises a radio frequency identification chip and a transparent antenna electrically connected thereto.

In one embodiment of the present invention, material of the transparent antenna comprises Indium Tin Oxide (ITO) or Indium Zinc Oxide (IZO).

In one embodiment of the present invention, the radio frequency identification module may be disposed on the LCD panel, organic electroluminescence display panel or plasma display panel.

The present invention provides a display module, which comprises a display panel, an outer frame and a radio frequency identification module wherein the circumference of the display panel is embedded into the outer frame. Additionally, the radio frequency identification module comprises a radio frequency identification chip and a transparent antenna, disposed on the display panel, electrically connected to the radio frequency identification chip.

In one embodiment of the present invention, material of the transparent antenna comprises Indium Tin Oxide (ITO) or Indium Zinc Oxide (IZO).

In one embodiment of the present invention, the display panel may comprise an active device array substrate, a color filter plate and a liquid crystal layer wherein the color filter plate is disposed on the active device array substrate, and the liquid crystal layer is disposed therebetween.

In one embodiment of the present invention, the display panel may be organic electroluminescence display panel or plasma display panel.

The present invention utilizes the installation of the antenna of the radio frequency identification module on the LCD display panel for easily reading all the fabricating information during the production management, the subsequent maintenance of each fabricating machine and improvement of production efficiency.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a top view of one LCD display panel module of one preferred embodiment of the present invention.

FIG. 2 shows a cross sectional view of the LCD display panel module of one preferred embodiment of the present invention as shown in FIG. 1.

### DESCRIPTION OF THE EMBODIMENTS

Reference will now be made in detail to a decoding device for product code decoding and decoding method thereof, examples of which are illustrated in the accompanying drawings. Wherever possible, the same reference numbers are used in the drawings and the descriptions to refer to the same parts.

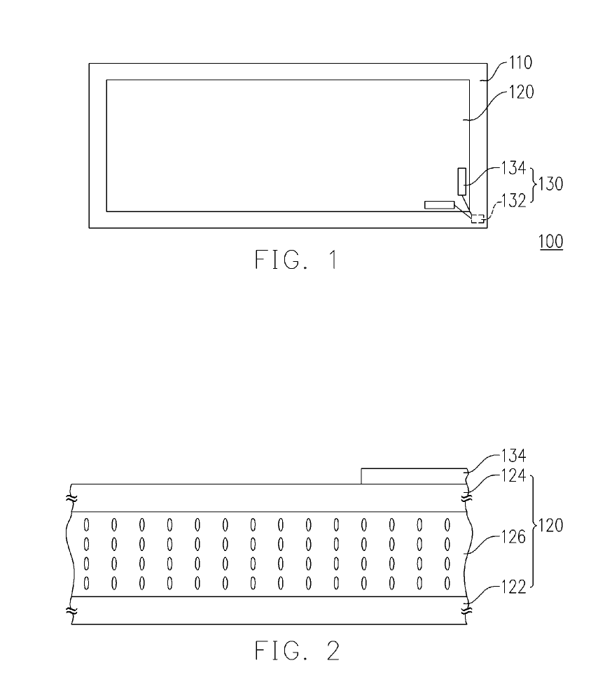

FIG. 1 schematically shows a top view of one LCD display panel module of one preferred embodiment of the present invention. FIG. 2 shows a cross sectional view of the LCD display panel module of one preferred embodiment of the present invention as shown in FIG. 1. Referring to FIGS. 1 and 2, a LCD display panel module 100 comprises an outer frame 110, an LCD display panel 120 and a radio frequency identification module 130 wherein the LCD display panel 120 comprises an active device array substrate 122, a color filter plate 124 and a liquid crystal layer 126. Additionally, the color filter plate 124 is upper to the active device array substrate 122, and the liquid crystal layer 126 is disposed between the active device array substrate 122 and the color filter plate 124. In one preferred embodiment, the active device array substrate 122 may be a thin film transistor substrate.

In addition, the radio frequency identification module 130 comprises a radio frequency identification chip 132 and a transparent antenna 134 wherein the transparent antenna 134 is disposed on the LCD display panel 120, and preferably, disposed in the circumference of the neighboring LCD display panel 120. In this embodiment, the transparent antenna 134 is disposed on the color filter plate 124 of the LCD display panel 120. Additionally, material of the transparent antenna comprises ITO or IZO and the transparent antenna 134 can be formed by printing or photolithography.

To enable one of ordinary skill in the art better understand the forming method of the transparent antenna 134, an embodiment is used as an example. In one preferred embodiment, the forming method of the transparent antenna 134 comprises first forming a transparent conductor film (not shown herein) by a sputtering method or other physical or chemical phase deposition methods for forming a photoresist layer on the transparent conductor film (not shown herein), followed by a photolithography and etching processes and patterning the transparent conductor film as the transparent antenna 134. This embodiment utilizes a mixture of water, HCl and HNO₃ to conduct the developing of the photoresist layer and etching of the transparent conductor film.

If a mask (not shown herein) is deposed on the LCD panel 120 with a pattern of the antenna prior to depositing the transparent conductor film, the transparent antenna 134 is readily formed on the LCD panel 120 without the need for photolithography after the deposition of the transparent conductor film.

The radio frequency identification chip 132 electrically connects to a transparent antenna 134, and preferably, the wireless radio frequency identification chip 132 is disposed inside the outer frame 110 to prevent views on the LCD panel 120 from being covered. The radio frequency identification chip 132 stores information of fabricating specification, quality and time of the LCD panel 120.

The present invention utilizes the disposition of the antenna of the radio frequency identification module on the LCD display panel for easy reading of all fabricating information during production management, subsequent maintenance of each fabricating machine and improvement of production efficiency.

Since the present invention utilizes transparent material to form the transparent antenna, views of the LCD display panel will not be covered regardless of the antenna disposed on the color filter plate or not.

It is noted that the embodiment above uses the LCD display panel as an example, but not limited to. One of ordinary skill should realize that the radio frequency identification module is applicable to the plasma display panel, the organic electroluminescence display panel, the plasma display panel or other display panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A radio frequency identification module, comprising:
a transparent antenna, disposed on a surface of a display panel ; and
a radio frequency identification chip, electrically connected to the transparent antenna.

2. The radio frequency identification module of claim 1, wherein material of the transparent antenna comprises Indium Tin Oxide or Indium Zinc Oxide.

3. The radio frequency identification module of claim 1, wherein the display panel is a plasma display panel, an organic electroluminescence display panel or a plasma display panel.

4. A display panel module, comprising:
an outer frame;
a display panel, the circumference of which is embedded into the outer frame;
a radio frequency identification module, comprising a wireless radio frequency identification chip and a transparent antenna being disposed on the display panel and electrically being connected to the radio frequency identification chip.

5. The display panel module of claim 4, wherein material of the transparent antenna comprises Indium Tin Oxide or Indium Zinc Oxide.

6. The display panel module of claim 4, wherein the radio frequency identification chip is disposed inside the outer frame.

7. The display panel module of claim 4, wherein the display panel comprises:
an active device array substrate;
a color filter plate, upper to the active device array substrate; and
a liquid crystal layer, disposed between the active device array substrate and the color filter plate.

8. The display panel module of claim 7, wherein the active device array substrate is a thin film transistor substrate.

9. The display panel module of claim 4, wherein the display panel is a plasma display panel, an organic electroluminescence display panel or a plasma display panel.
